(19) United States
(12) Patent Application Publication
(10) Pub. No.: US 2024/0430649 A1
(43) Pub. Date: Dec. 26, 2024

(54) WIRELESS SENSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Jianning LIU, Beijing (CN); Yang SHEN, Beijing (CN)

(73) Assignee: Beijing Xiaomi Mobile Software Co., Ltd., Beijing (CN)

(21) Appl. No.: 18/692,633

(22) PCT Filed: Sep. 18, 2021
(86) PCT No.: PCT/CN2021/119419

§ 371 Date: Mar. 15, 2024

(51) Int. Cl. H04W 4/38; H04W 8/22; H04W 28/24

(52) U.S. Cl. CPC H04W 4/38; H04W 8/22; H04W 28/24

(57) ABSTRACT

Provided in embodiments of the present disclosure are a wireless sensing method and apparatus, a communication device, and a storage medium. The method includes: based on a sensing service. sending a sensing service request to a sensing function. The sensing service request is at least used by the sensing function to configure a sensing parameter of the sensing service.

### CROSS REFERENCE TO RELATED APPLICATION

The present application is a U.S. National Stage of International Application No. PCT/CN2021/119419, filed on Sep. 18, 2021, the contents of which are incorporated herein by reference in its entirety for all purposes.

### BACKGROUND

### Technical Field

The present disclosure relates to, but is not limited to, the wireless communication technical field, and in particular, to a wireless sensing method and apparatus, a communication device and a storage medium.

### Description of the Related Art

Currently, developments of Artificial Intelligence (AI) technologies have greatly promoted the intelligence of many industries. Among them, the sensing technology has become an important technical foundation, for example, radar-based technology is widely used in the fields of smart transportation or autonomous driving, and so on. Current radar-based sensing technology mainly relies on dedicated radar equipment, which is expensive and inflexible in deployment, and such technology is mainly used in specific scenarios.

With the developments of mobile communications, the Internet of Everything will become an important direction in the future, and inter-device sensing and identification technology will become one of the key technologies. Temporary sensing needs may arise in many scenarios, such as walking in the woods without street lights at night, in which scenario a mobile phone may be used to sense surrounding situation to provide security and ensure quality of service.

### SUMMARY

Embodiments of the present disclosure provide a wireless sensing method and apparatus, a communication device and a storage medium.

According to an embodiment of the present disclosure, there is provided a wireless sensing method. The method is performed by an initiator, and the method includes:

based on a sensing service, sending a sensing service request to a sensing function, wherein the sensing service request is at least used by the sensing function to configure a sensing parameter of the sensing service.

According to a second aspect of embodiments of the present disclosure, there is provided a wireless sensing method. The method is performed by a sensing function, and the method includes receiving a sensing service request, based on the sensing service request, determining a sensing parameter, and sending the sensing parameter to an executor of a sensing service, wherein the executor includes: a transmitter which transmits a sensing signal, a receiver which receives a reflected signal that is generated by the sensing signal acting on a sensing target and outputs sensing data based on the reflected signal, and/or a processor which processes the sensing data.

According to a third aspect of embodiments of the present disclosure, there is provided a wireless sensing method. The method is performed by an executor, and the method includes receiving a sensing parameter from a sensing function, and providing a sensing service according to the sensing parameter.

According to a fourth aspect of embodiments of the present disclosure, there is provided a wireless sensing apparatus, including a sending module configured to, based on a sensing service, send a sensing service request to a sensing function, wherein the sensing service request is at least used by the sensing function to configure a sensing parameter of the sensing service.

According to a fifth aspect of embodiments of the present disclosure, there is provided a wireless sensing apparatus, including a receiving module configured to receive a sensing service request, a determination module configured to, based on the sensing service request, determine a sensing parameter, and a sending module configured to send the sensing parameter to an executor of a sensing service, wherein the executor includes: a transmitter which transmits a sensing signal, a receiver which receives a reflected signal that is generated by the sensing signal acting on a sensing target and outputs sensing data based on the reflected signal, and/or a processor which processes the sensing data.

According to a sixth aspect of embodiments of the present disclosure, there is provided a wireless sensing apparatus, including a receiving module configured to receive a sensing parameter from a sensing function, and a providing module configured to provide a sensing service according to the sensing parameter.

According to a seventh aspect of embodiments of the present disclosure, there is provided a communication device, including a processor, a transceiver, a memory and an executable program stored in the memory and capable of being run by the processor, wherein when the processor runs the executable program, the wireless sensing method according to the first aspect, or the second aspect or the third aspect is implemented.

According to an eighth aspect of embodiments of the present disclosure, there is provided a computer storage medium having an executable program stored thereon, wherein after the executable program is executed by a processor, the wireless sensing method according to the first aspect or the second aspect is implemented. It should be understood that the above general description and the following detailed description are only exemplary and explanatory, and do not limit the embodiments of the present disclosure.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic structural diagram of a wireless communication system according to an example embodiment;

FIG. 2 is a schematic diagram of a system architecture according to an example embodiment;

FIG. 3 is a schematic flowchart of a wireless sensing method according to an example embodiment;

FIG. 4 is a schematic diagram of a wireless sensing method based on a radar signal according to an example embodiment;

FIG. 5 is a schematic flowchart of a wireless sensing method according to an example embodiment;

FIG. 6 is a schematic flowchart of a wireless sensing method according to an example embodiment;

FIG. 7 is a schematic structural diagram of a wireless sensing apparatus according to an example embodiment;

FIG. 8 is a schematic structural diagram of a wireless sensing apparatus according to an example embodiment;

FIG. 9 is a schematic structural diagram of a wireless sensing apparatus according to an example embodiment;

FIG. 10 is a schematic structural diagram of a UE according to an example embodiment; and

FIG. 11 is a schematic structural diagram of a communication device according to an example embodiment.

### DETAILED DESCRIPTION OF THE PREFERRED EMBODIMENTS

Referring now to the drawings, wherein like reference numerals designate identical or corresponding parts throughout the several views.

Example embodiments will be described in detail herein, examples of which are illustrated in the accompanying drawings. When the following description refers to the drawings, the same numbers in different drawings refer to the same or similar elements unless otherwise indicated. The implementations described in the following example embodiments do not represent all implementations consistent with embodiments of the present disclosure. Rather, they are merely examples of apparatuses and methods consistent with some aspects of embodiments of the present disclosure as detailed in the appended claims.

The terms in the embodiments of the present disclosure are for the purpose of describing example embodiments only and are not intended to limit the embodiments of the present disclosure. As used in the embodiments of the present disclosure and the appended claims, the singular forms “a”, “an” and “the” are intended to include a plural form as well, unless the context clearly dictates otherwise. It will also be understood that the term “and/or” as used herein refers to and includes any and all possible combinations of one or more of associated listed items.

It should be understood that although the terms first, second, third, etc. may be used to describe various information in the embodiments of the present disclosure, the information should not be limited to these terms. These terms are only used to distinguish information of the same type from each other. For example, without departing from the scope of the embodiments of the present disclosure, first information may also be called second information, and similarly, second information may also be called first information. Depending on the context, the word “if” as used herein may be interpreted as “when” or “in a case where . . . ” or “in response to determining . . . ”.

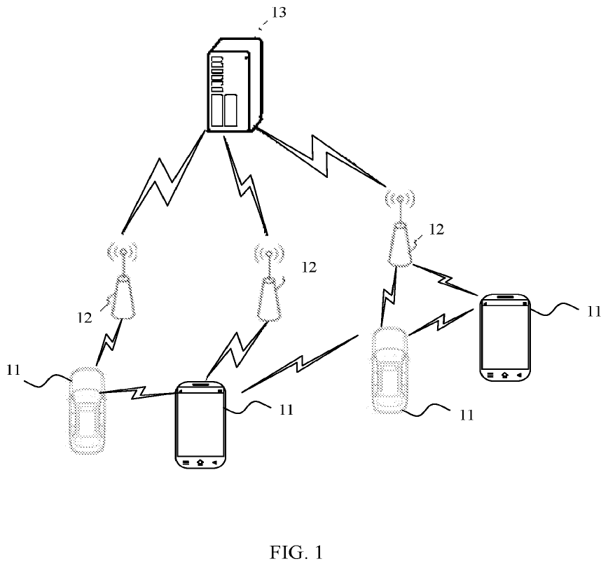

FIG. 1 shows a schematic structural diagram of a wireless communication system provided by an embodiment of the present disclosure. As shown in FIG. 1, the wireless communication system is a communication system based on cellular mobile communication technologies. The wireless communication system may include multiple UEs 11 and multiple access devices 12.

UE 11 may be a device that provides voice and/or data connectivity to a user. The UE 11 may communicate with one or more core networks via a Radio Access Network (RAN). The UE 11 may be an Internet of Things UE, such as a sensor device, a mobile phone (or referred to as a “cellular” phone), and a computer with an Internet of Things UE, for example, it can be a fixed, portable, pocket-sized, handheld, computer-built-in or vehicle-mounted device. For example, the UE 11 may be a station (STA), a subscriber unit, a subscriber station, a mobile station, a mobile, a remote station, an access point, a remote UE (remote terminal), an access UE (access terminal), a user terminal, a user agent, a user device, or user UE (user equipment). Alternatively, the UE 11 may be equipment of an unmanned aerial vehicle. Alternatively, the UE 11 may be a vehicle-mounted device, for example, it may be an on-board computer with a wireless communication function, or a wireless communication device connected to an external on-board computer. Alternatively, the UE 11 may be a roadside device, for example, it may be a streetlight, a signal light or other roadside device with a wireless communication function.

An access device 12 may be a network side device in a wireless communication system. The wireless communication system may be the 4th generation mobile communication (4G) system, also known as the Long Term Evolution (LTE) system; or, the wireless communication system may be a 5G system, also called new radio system or 5G NR system. Alternatively, the wireless communication system may be a next-generation system of the 5G system. The access network in the 5G system may be called New Generation-Radio Access Network (NG-RAN). Or, it may also be a MTC system.

The access device 12 may be an evolved access device (eNB) used in the 4G system. Alternatively, the access device 12 may be an access device (gNB) using a centralized distributed architecture in the 5G system. When the access device 12 adopts a centralized distributed architecture, it usually includes a central unit (CU) and at least two distributed units (DU). The central unit is provided with a protocol stack including a Packet Data Convergence Protocol (PDCP) layer, a Radio Link Control protocol (RLC) layer, and a Media Access Control (MAC) layer; a distributed unit is provided with a physical (PHY) layer protocol stack. The embodiments of the present disclosure do not limit the specific implementation of the access device 12.

A wireless connection may be established between an access device 12 and a UE 11 through a radio air interface. In different implementations, the radio air interface is a radio air interface based on the fourth generation mobile communication network technology (4G) standard; or, the radio air interface is a radio air interface based on the fifth generation mobile communication network technology (5G) standard, for example, the radio air interface is a new air interface; alternatively, the radio air interface may be a radio air interface based on the next generation mobile communication network technology standard of 5G.

In some embodiments, an End to End (E2E) connection may be established between UEs 11, for example, vehicle to vehicle (V2V) communication, vehicle to Infrastructure (V2I) communication and vehicle to pedestrian (V2P) communication in vehicle to everything (V2X) and so on.

In some embodiments, the above-mentioned wireless communication system may also include a network management device 13.

Multiple access devices 12 are connected to the network management device 13 respectively. The network management device 13 may be a core network device in a wireless communication system. For example, the network management device 13 may be a Mobility Management Entity (MME) in an Evolved Packet Core (EPC). Alternatively, the network management device may be other core network devices, such as Serving GateWay (SGW), Public Data Network GateWay (PGW), Policy and Charging Rules Function (PCRF) or Home Subscriber Server (HSS), etc. The embodiments of the present disclosure do not limit the implementation form of the network management device 13.

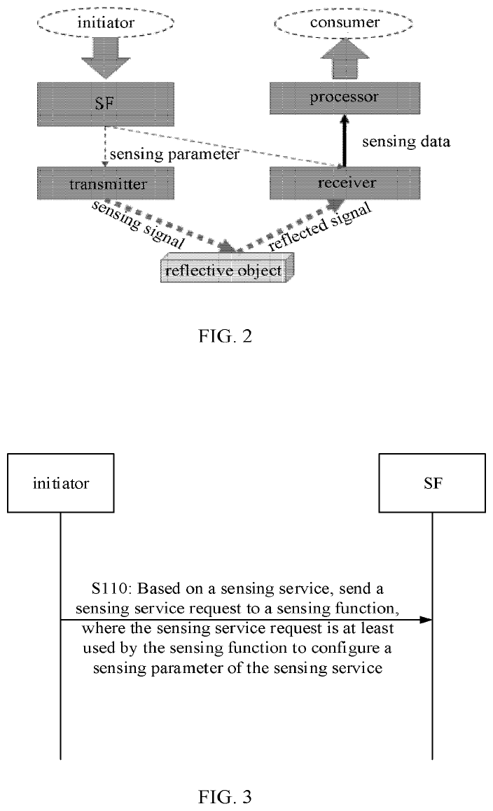

The wireless sensing method provided by the embodiments of the present disclosure may be applied to the system architecture shown in FIG. 2, but is not limited to the system architecture shown in FIG. 2.

Initiator: triggers a sensing service according to an application requirement, and may be out of a communication system corresponding to 3GPP.

Consumer: receives and consumes output data of the sensing service

Sensing Function (SF): the sensing function may be any function entity at the network side and is a type of network function; according to information/requirement provided by the initiator, the sensing function determines a sensing model, and determines a sensing parameter of a transmitter (or called transmitting device or transmitter device) and a receiver (or called receiving device or receiver device); the sensing parameter may be at least a parameter that is needed to coordinate reception/reception of a sensing signal between the transmitter and the receiver.

Transmitter: transmits a sensing signal according to the sensing parameter received from the SF.

Receiver: receives a reflected signal according to the sensing parameter received from the SF, and if there is sensing data, sends the sensing data to a processor.

Processor: processes the sensing data received from the receiver and outputs a sensing result. It should be noted that the processor here may include one or more processors, or one or more processing devices.

As shown in FIG. 3, an embodiment of the present disclosure provides a wireless sensing method. The method is performed by an initiator. The method includes the following step(s):

In S110, based on a sensing service, a sensing service request is sent to a sensing function. The sensing service request is at least used by the sensing function to configure a sensing parameter of the sensing service.

The initiator may be an end that initiates the sensing service. For example, a sensing service application program, mini program or system service is installed in a terminal device. Based on the sensing service, the initiator may send a sensing service request to a sensing function at the network side.

For example, if the initiator is a vehicle-mounted device, when the vehicle-mounted device starts an automatic driving function or starts an assisted driving function, a wireless sensing service is required to detect obstacles on the road surface, and at this time, the initiator automatically sends a sensing service request to the sensing function according to pre-configuration of the sensing service. As another example, the initiator may also be one or all of executors of the sensing service.

The pre-configuration of the sensing service includes but is not limited to: configuration information based on a communication protocol or sent by the network side. The configuration information provides a format for sending the sensing service request and/or address information of the sensing function that receives the sensing service request, and so on.

The sensing function may be any function entity at the network side. For example, the sensing function includes but is not limited to at least one of the following:

Access Function (AF);

Policy control function (PCF);

Access Management Function or other Network Function (NF).

After the sensing function receives the sensing service request, if it is agreed to provide the sensing service, the sensing function determines a sensing parameter. When the sensing parameter determined by the sensing service is provided to an executor who performs the sensing service, the quality and security in providing of the sensing service can be ensured.

The sensing parameter may be: any parameter required by the executor who provides the sensing service, for example, a sensing duration for providing the sensing service, a sensing region, a transmitting power of a sensing signal, a transmitting frequency of the sensing signal, and an accuracy requirement of a sensing result, and so on.

The sensing signal is a wireless signal. Specifically, the sensing signal may be: a radar signal, a laser or ultrasonic wave, or an electromagnetic wave used for time-of-flight ranging, and so on.

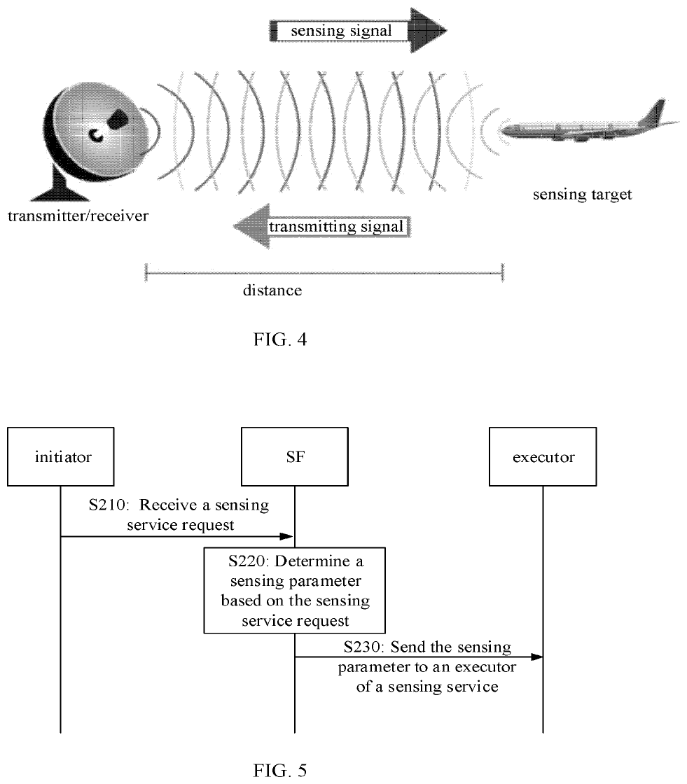

FIG. 4 shows wireless sensing based on a radar wave.

A transmitter transmits a radar signal. The radar signal is reflected or absorbed when it encounters an obstacle during transmission. The reflected radar wave is received by a receiver. Based on the received radar wave, the receiver can realize radar ranging, radar detection or other functions, so as to know a parameter such as the position, volume and/or shape of the obstacle.

Example use of the sensing service described in the embodiments of the present disclosure includes but is not limited to at least one of the following:

aircraft detection;

obstacle detection;

missile launch;

spacecraft navigation;

maritime navigation;

automatic driving;

weather detection; or

terrain detection, etc.

As shown in FIG. 4, based on the transmission time and reception time of the radar wave, information (for example, a distance between a sensing target and devices where the transmitter and receiver reside in, as well as a direction relative to the devices where the transmitter and receiver reside in) can be determined.

A carrier of the sensing signal sent in the wireless sensing may be a radar wave but is not limited to the radar wave, and may also be a carrier in other frequency band(s).

In some other embodiments, the sensing signal may be a pulse signal and is not limited to a continuous electromagnetic wave.

The sensing service request includes at least one of the following request parameters:

sensing target information;

service region information of the sensing service;

sensing duration information of the sensing service;

Quality of service (QOS) requirement information of the sensing service;

identity information of an optional transmitter, where the optional transmitter is capable of transmitting a sensing signal;

identity information of an optional receiver, where the optional receiver is capable of receiving a reflected signal that is generated by the sensing signal acting on the sensing target and outputting sensing data based on the reflected signal;

identity information of an optional processor, where the optional processor is capable of determining a sensing result based on the sensing data; optional sensing model information.

The sensing target information may be used to describe any information about the sensing target which the sensing service aims at. For example, the sensing target information may be used to describe the structure and/or shape characteristics of the sensing target, a current approximate position where the sensing target is, a device type, etc., so as to facilitate the sensing service to configure, based on the sensing target information, a sensing parameter based on which the sensing target can be detected.

The service region information indicates a sensing region. Due to the introduction of a mobile communication systems including a base station, the region covered by the network can be divided into different regions. Different regions have different network devices, which can be used as executor(s) of the sensing service to participate in the provision of the sensing service.

The sensing duration information of the sensing service, for example, is equivalent to limiting the provision time of the sensing service. This information can facilitate the sensing function to schedule an executor available within this duration to provide the wireless sensing service.

The QoS requirement information of the sensing service indicates a QoS requirement of the sensing service. Different uses or different scenarios have different QoS requirements for the wireless sensing. For example, some sensing services allow a relatively large delay, while some sensing services are very sensitive to a delay. For example, in intelligent driving or assisted driving, road safety is involved, and a delay allowed in intelligent driving or assisted driving is smaller than a delay allowed by landform detection.

For another example, when the wireless sensing is used for distance detection and obstacle detection, the distance accuracy requirements may be different, and both of the requirements are reflected in QoS requirements, which can be indicated by the QoS requirement information.

Through the provision of the QoS requirement information, it is convenient for the Sensing Function (SF) at the network side to configure an appropriate sensing parameter and schedule an appropriate executor to provide the sensing service.

In some embodiments, the initiator itself can act as an executor of the wireless sensing service, or has already known in advance some devices that may act as the executor of the sensing service. At this time, the sensing service request may carry identity information of an optional transmitter, identity information of an optional receiver, and identity information of an optional processor.

The identity information may be a device identity, such as an International Mobile Equipment Identity (IMEI), or may be temporarily assigned information. For example, assuming that a base station serves as an optional transmitter or an optional receiver of wireless sensing, the identity information may be cell identification (ID) of a cell formed by the base station. Specifically, the ID may be Physical Cell Identification (PCI).

The optional sensing model information may indicate a sensing model that the initiator expects to use, or a sensing model that the initiator recommends to use based on a triggering scenario of the current sensing service or a triggering application program.

For example, different sensing models have different executors; and/or different sensing models have different types of sensing signals, and so on.

The sensing service request may include one or more of the above information. Alternatively, the sensing service request may not carry the above information, and may only carry request signaling for the sensing service.

In some embodiments, the request parameter may further include: consumer information indicating a consumer of the sensing service. The sensing result of the sensing service is sent to the consumer for the consumer to use.

In one embodiment, the initiator and consumer may be the same or different.

For example, two mandatory fields and one or more optional fields are set in the sensing service request. The two mandatory fields may carry initiator information and consumer information, respectively, while other optional field(s) may carry various information such as the aforementioned sensing target information. Of course, this is just an example, and the specific implementation is not limited to this.

By carrying one or more of the above request parameters, it is convenient for the SF to determine the sensing parameter suitable for the current scenario, thereby ensuring the service quality of the sensing service.

Exemplarily, the sensing target information includes at least one of the following: area of the sensing target;

region information of the sensing target;

a position of the sensing target;

a volume of the sensing target; or

a speed of the sensing target.

In some embodiments, sensing targets of different areas and/or volumes may be used to determine parameters such as the viewing angle and/or power for the transmitter to send the sensing signal.

The region information of the sensing target may indicate a region where the sensing target is currently located, and this information can facilitate the determination of the sensing service region.

The position of the sensing target may be used to determine the executor, for example, to select a suitable executor nearby to perform the sensing service.

The speed of the sensing target may affect the successful provision of sensing services. For example, a high-speed moving object has requirements for the transmitter's transmitting power in the sensing service. In addition, the Doppler effect may also be generated due to the movement of the sensing target. At this time, there are certain requirements on the processing capability of the processor that provides the sensing service.

In some embodiments, the sensing target information is not limited to the above-mentioned area, position, volume and/or speed, but may also be the type of the sensing target. For example, depending on whether a sensing target is moving or not, the sensing target can be classified as a static sensing target or a dynamic sensing target. Depending on whether a sensing target is a living body, the sensing target may be classified a living body target or a non-living body target. For a living body target, it may be needed to consider the influence of the radar spot on the living body, such as a negative effect on the living body, and so on.

In short, the initiator may send the request parameter through the sensing service request, the SF may determine the sensing parameter based on the request parameter and/or network information other than the request parameter, and the executor may provide, based on the sensing parameter, a sensing service with a guaranteed security and service quality.

As shown in FIG. 6, an embodiment of the present disclosure provides a wireless sensing method. The method is performed by a sensing function. The method includes the following steps:

In S210, a sensing service request is received.

In S220, a sensing parameter is determined based on the sensing service request.

In S230, the sensing parameter is sent to an executor of a sensing service; where the executor includes: a transmitter which transmits a sensing signal, a receiver which receives a reflected signal that is generated by the sensing signal acting on a sensing target and outputs sensing data based on the reflected signal, and/or a processor which processes the sensing data.

The sensing function provided by the embodiments of the present disclosure is located at the network side, for example, in a core network connected to a base station.

After receiving the sensing service request, the SF determines the sensing parameter based on the sensing service request. The sensing parameter provides a reference for the executor to provide the sensing service. In some embodiments, the sensing service request may carry request parameter(s), and the sensing parameter is determined according to one or more of the request parameter(s).

The sensing parameter may be configured by the network side and sent to the executor. For example, the sensing parameter may be sent to the executor by RRC signaling, MAC signaling or DCI. If the sensing parameter is sent to the executor through RRC signaling, the network side configuration corresponding to the sensing parameter is an RRC configuration. If the sensing parameter is sent to the executor through MAC CE, the network side configuration corresponding to the sensing parameter is MAC CE.

Exemplarily, the sensing service request includes at least one of the following request parameters:

sensing target information; service region information of the sensing service;

sensing duration information of the sensing service;

Quality of Service (QOS) requirement information of the sensing service;

identity information of an optional transmitter, wherein the optional transmitter is capable of transmitting a sensing signal;

identity information of an optional receiver, wherein the optional receiver is capable of receiving a reflected signal that is generated by the sensing signal acting on the sensing target and outputting sensing data based on the reflected signal;

identity information of an optional processor, wherein the optional processor is capable of determining a sensing result based on the sensing data; or

optional sensing model information.

The specific content of the above request parameters can be found in the foregoing embodiments, and will not be repeated here.

In some embodiments, the sensing parameter includes at least one of the following:

sensing target information;

sensing service information;

sensing service region information;

sensing duration information;

sensing QoS requirement information;

sensing model information;

data format information of sensing data; or

processing algorithm information of the sensing data.

The sensing target information describes information of the sensing target. For example, for landform detection, the sensing target may be a region range of the ground to be detected. As another example, for obstacle detection in road assisted driving or automatic driving, the sensing target may be a road obstacle, and the sensing target information may be an item and/or a living body within a preset distance from the current vehicle.

Based on the sensing target information, the SF configures the sensing parameter based on which the sensing target can be detected.

The service region information indicates a sensing region. Due to the introduction of a mobile communication system including a base station, the region covered by the network can be divided into different regions. Different regions have different network devices, which can be used as the executor of a sensing service to participate in the provision of the sensing service.

The sensing duration information of the sensing service, for example, is equivalent to limiting the provision time of the sensing service. The information can facilitate the sensing function to schedule an executor available within the duration to provide the wireless sensing service.

The sensing model information indicates a sensing model for providing this sensing service. Different sensing models may have different executors of the sensing service or different types of sensing signals or sensing methods.

The data format information of the sensing data may indicate the receiver to store and encapsulate the sensing data in a data format indicated by the data format information after receiving the reflected signal generated based on the sensing signal.

The processing algorithm information of the sensing data indicates an algorithm used by the processor to process the sensing data to obtain the sensing result. For example, the processing algorithm indicated by the processing algorithm information includes but is not limited to: Time of Flight (ToF) or a triangulation ranging algorithm, etc.

The processor obtains the sensing data from the receiver and may process the sensing data according to a processing algorithm indicated by the processing algorithm information to obtain a sensing result.

The sensing result includes but is not limited to at least one of the following:

a relative position between the sensing target and the initiator or the transmitter;

a change rate of the relative position between the sensing target and the initiator or the transmitter; or

structural information of the sensing target, such as shape, volume and/or area, etc.

In some embodiments, the sensing model information indicates at least one of the following models:

a first sensing model in which a base station serves as the transmitter and the receiver;

a second sensing model in which User Equipment (UE) serves as the transmitter and the receiver;

a third sensing model in which the base station serves as the transmitter and the UE serves as the receiver;

a fourth sensing model in which the UE serves as the receiver and the base station serves as the transmitter; or

a fifth sensing model other than the first to fourth sensing models.

If the base station serves as the transmitter and receiver, it is equivalent to the sensing service being completely performed by a network element of the mobile communication network system.

In the first sensing model, a processor may also be involved, and the processor may be a base station, or a computing device near the base station, or a UE, or the like. The computing device includes, but is not limited to, an edge computing device or a computing device that is remotely connected.

In the second sensing model in which at least one UE serves as the transmitter and receiver, at least the transmission and reception of the sensing signal are performed by one or more UEs. At this time, the UE serving as the transmitter and the UE serving as the receiver in the second sensing model may be the same UE or different UEs.

In the second sensing model, a processor may also be involved. The processor may be a UE, or a base station, or a computing device connected to the base station. The computing device includes, but is not limited to, an edge computing device or a computing device that is remotely connected.

The third sensing model involves a base station and UE(s), with the base station serving as the transmitter and the UE(s) serving as the receiver. In this case, the base station, as a transmitter, may transmit a sensing signal to multiple UEs, realizing one-to-many sensing service provision, and thereby providing the sensing service to different UEs.

In the third sensing model, a processor may also be involved. The processor may be a UE, or a base station or, a computing device connected to the base station. The computing device includes, but is not limited to, an edge computing device or a computing device that is remotely connected.

The fourth sensing model involves a base station and UE(s), with the base station serving as the receiver and the UE(s) serving as the transmitter. In this case, the base station, as the receiver, may receive sensing signals transmitted by multiple UEs at one time due to its strong receiving capability, realizing one-to-many sensing service provision and thus providing the sensing service to different UEs.

In the fourth sensing model, a processor may also be involved. The processor may be a UE, or a base station, or a computing device connected to the base station. The computing device includes, but is not limited to, an edge computing device or a computing device that is remotely connected.

The fifth sensing model may be any sensing model other than the aforementioned first to fourth sensing models.

Exemplarily, the fifth sensing model may include: a sensing model in which multiple transmitters and/or multiple receivers are involved and the types of the multiple transmitters may be different. For example, the transmitters may include both UE(s) and base station(s); and/or, the receivers may include both UE(s) and base station(s). Of course, devices serving as transmitters and receivers include but are not limited to base station(s) and/or UE(s). In specific implementation, a device serving as the transmitter and/or receiver may also be a roadside device capable of establishing a connection with the base station or UE, for example, a roadside monitoring device with wireless signal sending and receiving capabilities, etc. The monitoring device includes but is not limited to a visual monitoring device mainly focusing on image collection.

In some embodiments, sending the sensing parameter to the executor of the sensing service includes at least one of the following:

sending the sensing parameter to the executor through user interface; or

sending the sensing parameter to the executor through a control plane.

After the SF at the network side determines the sensing parameter, the SF may send the sensing parameter to the executor through a Control Plane (CP) or through a User Plane (UP).

If the sensing parameter is sent to the executor through the CP, the sensing parameter is carried in Signaling Bearer (SB) and sent to the executor. If the sensing parameter is sent to the executor through the UP, the sensing parameter is carried in Data Bearer (DB) and sent to the executor.

In some embodiments, the SF may select the user plane or the control plane to send the sensing parameter to the executor according to the QoS requirement of the current sensing service, so as to provide the sensing service adapted to the required sensing.

In some cases, the SF determines the transmitter, the receiver and the processor that provide this sensing service based on the sensing model adopted. S230 may include at least one of the following:

according to a selected transmitter, sending at least a transmission parameter in the sensing parameter to the transmitter through CP or UP;

according to a selected receiver, sending at least a receiving parameter in the sensing parameter to the receiver through CP or UP; or

according to a selected processor, sending at least a processing parameter in the sensing parameter to the processor through CP or UP.

In some embodiments, in order to better achieve effective transmission and reception of the sensing signal between the receiver and the transmitter, the receiving parameter may also be sent to the transmitter, and/or the transmitting parameter may be sent to the receiver, and/or at least one of the transmitting parameter and the receiving parameter is sent to the processor, so that the processor can better process the sensing data.

In some embodiments, the method further includes:

when the SF determines that there are multiple executors and the multiple executors are located in different device entities, sending information of one of the executors to another executor. For example, if the transmitter and the receiver are distributed on different separate device entities, in order to achieve effective sending and reception of the sensing signal between the transmitter and the receiver, the receiver's device type information and/or device capability information may be sent to the transmitter; and/or, the transmitter's device type information and/or device capability information may be sent to the receiver; in a case where the SF does not give a specific sensing parameter, the transmitter and receiver may, according to their own device type information and/or device capability information and the device type information and/or device capability information of their opposite end devices, perform negotiation to obtain a specific sensing parameter.

For example, when the SF does not provide the transmitting frequency of the sensing signal and/or the type of the sensing signal, the transmitter and the receiver may select a transmitting frequency and a type of the sensing signal that are supported by both the transmitter and the receiver according to their own device capabilities and the device capabilities of the opposite end device(s).

Of course, the above are just examples, and the specific implementation is not limited to the above examples. For example, if the SF knows the device type information and device capability information of the transmitter and the executor, the SF may directly determine an appropriate sensing parameter based on the device type information and/or device capability information of the transmitter and/or receiver, and directly send specific sensing parameter(s) such as the transmitting frequency of the sensing signal and/or the type of the sensing signal to a corresponding executor.

As shown in FIG. 6, an embodiment of the present disclosure provides a wireless sensing method. The method is performed by an executor. The method includes the following steps:

In S310, a sensing parameter is received from a sensing function.

In S320, a sensing service is provided according to the sensing parameter.

The executor in embodiments of the present disclosure may serve as one or more of a receiver, a transmitter, and a processor.

The executor receives the sensing parameter from the SF and provides the sensing service based on the sensing parameter.

For example, if the executor is a transmitter, the executor provides a transmitting service for transmitting a sensing signal in the sensing service. If the executor is a receiver, the executor provides a receiving service for receiving a reflected signal generated based on the sensing signal in the sensing service. If the executor is a processor, the executor obtains sensing data from the receiver, processes the sensing data and outputs a sensing result.

The executor involved in the embodiments of the present disclosure may be a UE, a network element, a roadside device connected to the network, or other device that can access the network.

Receiving the sensing parameter from the SF and providing the sensing service based on such sensing parameter can ensure the security and communication quality of the sensing service.

In some embodiments, receiving the sensing parameter from the sensing function includes receiving the sensing parameter through the user plane or receiving the sensing parameter through the control plane.

The sensing parameter may be sent through the CP and/or UP. Whether the sensing parameter is received through CP or UP may be determined according to a network side configuration. The network side configuration may be specifically determined by the network side according to its own load rate and/or the application scenario of the sensing service, so as to provide the sensing service that suits the needs of the current application scenario and complies with the current network conditions.

In some embodiments, S320 may include at least one of the following:

transmitting, by the executor which is a transmitter, the sensing signal according to a transmitting parameter in the sensing parameter;

receiving according to a receiving parameter in the sensing parameter, by the executor which is a receiver, a reflected signal that is generated by the sensing signal acting on the sensing target and generating sensing data based on the received reflected signal;

processing, by the executor which is a processor, the sensing data according to a processing parameter in the sensing parameter to obtain a sensing result.

In one embodiment, any two or three of the receiver, the transmitter and the processor correspond to the same entity device.

In some embodiments, the executor includes a processor, and the method further includes sending the sensing result to a consumer. The consumer here is the receiver of the sensing result. The consumer may be an initiator. The consumer may be a server connected to the initiator.

For example, for locally controlled assisted driving or intelligent driving, the initiator and consumer of the sensing service may be the same vehicle-mounted device.

As another example, for remotely controlled assisted driving or intelligent driving, the initiator of the sensing service may be a vehicle-mounted device, and the consumer may be a cloud server connected to and controlling the vehicle-mounted terminal.

Of course, the above are just examples, and the specific implementation is not limited to the above examples.

The initiator decides to request a sensing service from the 3GPP system based on a sensing service requirement, such as target object information (such as area, position, size, speed, etc.), sensing QoS requirement, and optional identities of the processor/transmitter/receiver.

The SF may be AF/PCF/AMF, or other NF, and receives the sensing service request sent by the initiator. The sensing service request includes a necessary request parameter. For example, the request parameter may be target object information, sensing service information, sensing service region, sensing duration information, or QoS requirement, etc.

The SF determines a relevant sensing parameter such as a sensing model, an optional sensing model or an optional sensing algorithm and so on according to the received sensing service requirement and a local policy, consumer subscription, or target object information. The sensing service requirement may be carried by the sensing service request, or may be determined by the network side according to relevant information such as initiator information.

The sensing parameter may indicate at least one of the following:

a sensing model that represents a role in the sensing service, where the sensing model includes but is not limited to:

m1: gNB as a transmitter and a receiver;

m2: a terminal as a transmitter and a receiver;

m3: gNB as a transmitter and UE as a receiver;

m4: gNB as a receiver and gNB as a transmitter; or

m5: other model(s);

a sensing method, such as To F and/or other.

The sensing function delivers the sensing parameter to the transmitter and receiver through the CP or UP.

The transmitter starts sending a sensing signal through the CP or UP according to the sensing parameter received from the SF.

The receiver receives a reflected sensing signal according to the parameter received from the SF and optionally includes necessary processing (if needed) to output the expected/defined sensing data to the processor for further processing.

The processor processes the sensing data from the receiver and calculates the results using defined method, if needed.

The consumer receives and consumes the output calculated from the sensing data. The output is the aforementioned sensing result.

The receiver and processor may be the same entity. The transmitter and receiver may also be the same entity. The initiator and consumer may be the same entity. The processor may be the same as the sensing function.

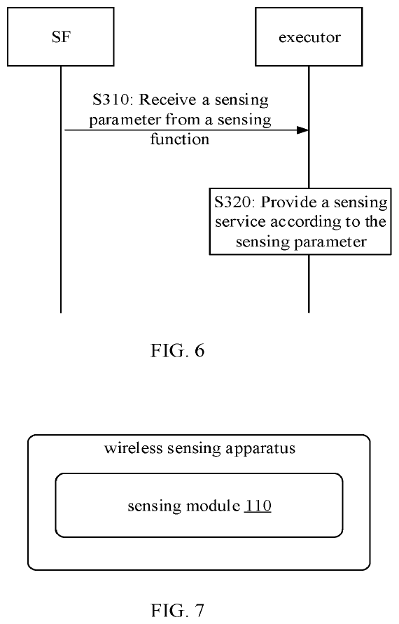

As shown in FIG. 7, an embodiment of the present disclosure provides a wireless sensing apparatus. The apparatus includes a sending module 110.

The sending module 110 is configured to, based on a sensing service, send a sensing service request to a sensing function, wherein the sensing service request is at least used by the sensing function to configure a sensing parameter of the sensing service.

In one embodiment, the sending module 110 may be a program module. After the program module is executed by a processor, the sensing service request may be sent to the sensing function.

In another embodiment, the sending module 110 may be a combination of software and hardware modules. The combination of software and hardware includes, but is not limited to, various programmable arrays; the programmable arrays include, but are not limited to: field programmable arrays and/or complex programmable arrays.

In some embodiments, the sending module 110 may be a pure hardware module. The pure hardware module includes but is not limited to: an application specific integrated circuit.

In an embodiment, the sensing service request includes at least one of the following request parameters:

sensing target information;

service region information of the sensing service;

sensing duration information of the sensing service;

Quality of Service (QOS) requirement information of the sensing service;

identity information of an optional transmitter, wherein the optional transmitter is capable of transmitting a sensing signal;

identity information of an optional receiver, wherein the optional receiver is capable of receiving a reflected signal which is generated by the sensing signal acting on a sensing target and outputting sensing data based on the reflected signal;

identity information of an optional processor, wherein the optional processor is capable of determining a sensing result based on the sensing data; or

optional sensing model information.

In an embodiment, the sensing target information includes at least one of:

area of the sensing target;

region information of the sensing target;

a position of the sensing target;

a volume of the sensing target; or

a speed of the sensing target.

As shown in FIG. 8, an embodiment of the present disclosure provides a wireless sensing apparatus. The apparatus includes a receiving module 210, a determination module 220 and a sending module 230.

The receiving module 210 is configured to receive a sensing service request.

The determination module 220 is configured to, based on the sensing service request, determine a sensing parameter.

The sending module 230 is configured to send the sensing parameter to an executor of a sensing service, wherein the executor includes: a transmitter which transmits a sensing signal, a receiver which receives a reflected signal that is generated by the sensing signal acting on a sensing target and outputs sensing data based on the reflected signal, and/or a processor which processes the sensing data.

In one embodiment, the receiving module 210, the determining module 220, and the sending module 230 may be program modules. After the program modules are executed by a processor, the sensing service request may be received, the sensing parameter may be determined, and the determined sensing parameter may be sent to an executor.

In another embodiment, the receiving module 210, the determining module 220 and the sending module 230 may be combinations of software and hardware modules. The combinations of software and hardware modules include but are not limited to various programmable arrays. The programmable arrays include but are not limited to: field programmable arrays and/or complex programmable arrays.

In some embodiments, the receiving module 210, the determining module 220 and the sending module 230 may be pure hardware modules. The pure hardware modules include but are not limited to: application specific integrated circuits.

In an embodiment, the sensing parameter includes at least one of:

sensing target information;

sensing service information;

region information of the sensing service;

sensing duration information;

sensing Quality of Service (QOS) requirement information;

sensing model information;

data format information of the sensing data; or

processing algorithm information of the sensing data.

In an embodiment, the sensing model information includes at least one of the following models:

a first sensing model in which a sensing base station serves as a transmitter and a receiver;

a second sensing model in which User Equipment (UE) serves as the transmitter and the receiver;

a third sensing model in which a base station serves as the transmitter and the UE serves as the receiver;

a fourth sensing model in which the UE serves as the receiver and the base station serves as the transmitter; or

a fifth sensing model other than the first sensing model to the fourth sensing model.

In an embodiment, the sending module is configured to perform at least one of:

sending the sensing parameter to the executor through a user plane; or

sending the sensing parameter to the executor through a control plane.

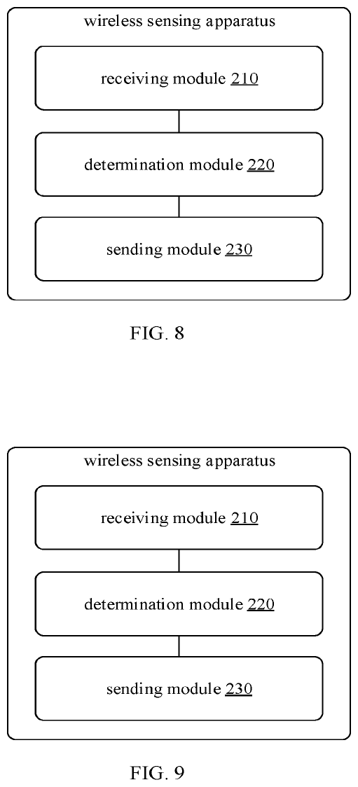

As shown in FIG. 9, an embodiment of the present disclosure provides a wireless sensing apparatus. The apparatus includes a receiving module 310 and a providing module 320.

The receiving module 310 is configured to receive a sensing parameter from a sensing function.

The providing module 320 is configured to provide a sensing service according to the sensing parameter.

In one embodiment, the receiving module 310 and the providing module 320 may be program modules. After the receiving module 310 and the providing module 320 are executed by a processor, a sensing parameter may be received, and a sensing service may be provided based on the sensing parameter.

In another embodiment, the receiving module 310 and the providing module 320 may be combinations of software and hardware modules. The combinations of software and hardware modules include, but are not limited to, various programmable arrays. The programmable arrays include, but are not limited to: field programmable arrays and/or complex programmable arrays.

In some embodiments, the receiving module 310 and the providing module 320 may be pure hardware modules. The pure hardware modules include but are not limited to: application specific integrated circuits.

In an embodiment, the receiving module is configured to: receive the sensing parameter through a user plane; or, receive the sensing parameter through a control plane.

In an embodiment, the providing module is configured to perform at least one of:

transmitting, by the executor which is a transmitter, a sensing signal according to a transmitting parameter in the sensing parameter;

receiving according to a receiving parameter in the sensing parameter, by the executor which is at least one receiver, a reflected signal that is generated by the sensing signal acting on a sensing target, and generating sensing data based on the received reflected signal; or

processing, by the executor which is a processor, the sensing data according to a processing parameter in the sensing parameter to obtain a sensing result.

In an embodiment, any two or three of the receiver, the transmitter and the processor correspond to a same entity device.

In an embodiment, the executor includes the processor, and the apparatus further includes:

a sending module configured to send the sensing result to a consumer.

In an embodiment, the at least one receiver includes one receiver or a plurality of receivers.

An embodiment of the present disclosure provides a communication device, including a memory configured to store instructions executable by a processor that is connected with the memory. The processor is configured to perform a wireless sensing method of a terminal provided by any of the foregoing technical solutions.

The processor may include various types of storage medium, which may be non-transitory computer storage medium that can continue to memorize information stored thereon after the communication device is powered off.

Here, the communication device includes: UE, base station, or SR or other communication device.

The processor may be connected to the memory through a bus or the like, and may be configured to read the executable program stored in the memory, for example, at least one of the methods shown in FIG. 3, FIG. 5 to FIG. 6.

In the technical solutions provided by the embodiments of the present disclosure, a mobile communication system including a base station is introduced into a wireless sensing system to provide a wireless sensing service. When providing a sensing service, an initiator sends a sensing request to a network side sensing entity, and the sensing entity determines a sensing parameter based on the sensing request, so that the mobile communication system including the base station provides the sensing service based on the sensing parameter provided by the sensing entity. Thus, the technical solutions can ensure the security and sensing quality in providing of the sensing service.

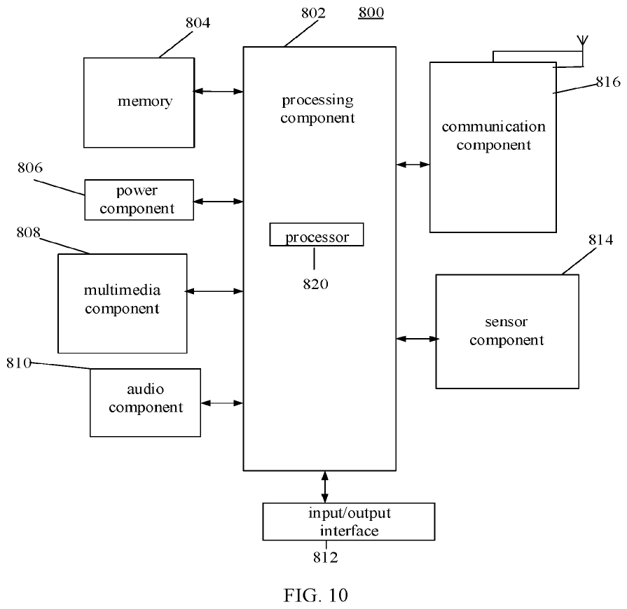

FIG. 10 is a block diagram of a UE 800 according to an example embodiment. For example, the UE 800 may be a mobile phone, a computer, digital broadcast user equipment, a messaging device, a gaming console, a tablet, a medical device, exercise equipment, a personal digital assistant, and the like.

Referring to FIG. 10, the UE 800 may include one or more of the following components: a processing component 801, a memory 804, a power component 806, a multimedia component 808, an audio component 810, an input/output (I/O) interface 812, a sensor component 814, and a communication component 816.

The processing component 802 typically controls overall operations of the UE 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the UE 800. Examples of such data include instructions for any applications or methods operated on the UE 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the UE 800. The power component 800 may include a power management system, one or more power sources, and any other components associated with the generation, management, and distribution of power in the UE 800.

The multimedia component 808 includes a screen providing an output interface between the UE 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the UE 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the UE 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the UE 800. For instance, the sensor component 814 may detect an open/closed status of the UE 800, relative positioning of components, e.g., the display and the keypad, of the UE 800, a change in position of the UE 800 or a component of the UE 800, a presence or absence of user contact with the UE 800, an orientation or an acceleration/deceleration of the UE 800, and a change in temperature of the UE 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the UE 800 and other devices. The UE 800 can access a wireless network based on a communication standard, such as WiFi, 2G, or 3G, or a combination thereof. In one example embodiment, the communication component 816 receives a broadcast signal or broadcast associated information from an external broadcast management system via a broadcast channel. In one example embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the UE 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as the memory 804 including instructions executable by the processor 820 in the UE 800, for performing the above-described methods. For example, the non-transitory computer-readable storage medium may be a ROM, a Random Access Memory (RAM), a CD-ROM, a magnetic tape, a floppy disc, an optical data storage device, and the like.

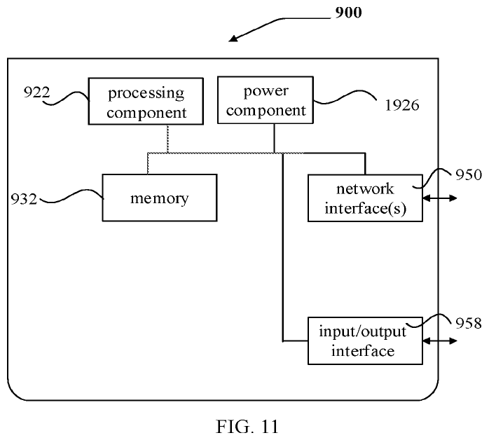

As shown in FIG. 11, an embodiment of the present disclosure shows a structure of an access device. For example, a communication device 900 may be provided as a network side device. The communication device may be the above described access device and/or core network device. A typical access device includes but is not limited to a base station. The core network device here includes but is not limited to the above described SF.

Referring to FIG. 11, the communication device 900 includes a processing component 922 that further includes one or more processors, and memory resources represented by a memory 932 for storing instructions executable by the processing component 922, such as application programs. The application programs stored in the memory 932 may include one or more modules each corresponding to a set of instructions. Further, the processing component 922 is configured to execute the instructions to perform any of the above described methods which are applied at the initiator, the SF and/or the executor, for example, the methods shown in FIG. 3, FIG. 5 to FIG. 6.

The communication device 900 may also include a power component 926 configured to perform power management of the communication device 900, wired or wireless network interface(s) 950 configured to connect the communication device 900 to a network, and an input/output (I/O) interface 958. The communication device 900 may operate based on an operating system stored in the memory 932, such as Windows Server™, Mac OS X™, Unix™, Linux™, FreeBSD™, or the like.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

Obviously, numerous modifications and variations of the present invention are possible in light of the above teachings. It is therefore to be understood that within the scope of the appended claims, the invention may be practiced otherwise than as specifically described herein.

1. A wireless sensing method, performed by a system comprising an initiator, and the method comprising:
based on a sensing service, sending, by the initiator, a sensing service request to a sensing function, wherein the sensing service request is at least used by the sensing function to configure a sensing parameter of the sensing service.

2. The method according to claim 1, wherein the sensing service request comprises at least one of the following request parameters:
sensing target information;
service region information of the sensing service;
sensing duration information of the sensing service;
Quality of Service (QOS) requirement information of the sensing service;
identity information of an optional transmitter, wherein the optional transmitter is capable of transmitting a sensing signal;
identity information of an optional receiver, wherein the optional receiver is capable of receiving a reflected signal which is generated by the sensing signal acting on a sensing target and outputting sensing data based on the reflected signal;
identity information of an optional processor, wherein the optional processor is capable of determining a sensing result based on the sensing data; or
optional sensing model information.

3. The method according to claim 2, wherein the sensing target information comprises at least one of:
region information of the sensing target;
a position of the sensing target;
a volume of the sensing target; or
a speed of the sensing target.

4. The wireless sensing method according to claim 1, wherein the system further comprises the sensing function and the method further comprises:
receiving, by the sensing function, the sensing service request;
based on the sensing service request, determining, by the sensing function, the sensing parameter; and
sending, by the sensing function, the sensing parameter to an executor of a sensing service, wherein the executor comprises: a transmitter which transmits a sensing signal, a receiver which receives a reflected signal that is generated by the sensing signal acting on a sensing target and outputs sensing data based on the reflected signal, and/or a processor which processes the sensing data.

5. The method according to claim 4, wherein the sensing parameter comprises at least one of:
sensing target information;
sensing service information;
region information of the sensing service;
sensing duration information;
sensing Quality of Service (QOS) requirement information;
sensing model information;
data format information of the sensing data; or
processing algorithm information of the sensing data.

6. The method according to claim 5, wherein the sensing model information comprises at least one of the following models:
a first sensing model in which a sensing base station serves as a transmitter and a receiver;
a second sensing model in which User Equipment (UE) serves as the transmitter and the receiver;
a third sensing model in which a base station serves as the transmitter and the UE serves as the receiver;
a fourth sensing model in which the UE serves as the receiver and the base station serves as the transmitter; or
a fifth sensing model other than the first sensing model to the fourth sensing model.

7. The method according to claim 4, wherein sending the sensing parameter to the executor of the sensing service comprises at least one of:
sending, by the sensing function, the sensing parameter to the executor through a user plane; or
sending, by the sensing function, the sensing parameter to the executor through a control plane.

8. The A-wireless sensing method according to claim 1, wherein the system further comprises an executor and the method further comprises:
receiving, by the executor, the sensing parameter from the sensing function; and
providing, by the executor, the sensing service according to the sensing parameter.

9. The method according to claim 8, wherein receiving the sensing parameter from the sensing function comprises:
receiving, by the executor, the sensing parameter through a user plane; or,
receiving, by the executor, the sensing parameter through a control plane.

10. The method according to claim 8, wherein providing the sensing service according to the sensing parameter comprises at least one of:
transmitting, by the executor which is a transmitter, a sensing signal according to a transmitting parameter in the sensing parameter;
receiving according to a receiving parameter in the sensing parameter, by the executor which is at least one receiver, a reflected signal that is generated by the sensing signal acting on a sensing target, and generating sensing data based on the received reflected signal; or
processing, by the executor which is a processor, the sensing data according to a processing parameter in the sensing parameter to obtain a sensing result.

11-12. (canceled)

13. The method according to claim 10, wherein the at least one receiver comprises one receiver or a plurality of receivers.

14. A communication device, comprising:
a processor; and
a memory configured to store instructions executable by the processor;
wherein when the instructions are executed by the processor, the processor is caused to perform the method according to claim 1.

15-26. (canceled)

27. A communication device, comprising:
a processor; and
a memory configured to store instructions executable by the processor;
wherein when the instructions are executed by the processor, the communication device is caused to:
receive the sensing service request;
based on the sensing service request, determine the sensing parameter; and
send the sensing parameter to an executor of a sensing service, wherein the executor comprises: a transmitter which transmits a sensing signal, a receiver which receives a reflected signal that is generated by the sensing signal acting on a sensing target and outputs sensing data based on the reflected signal, and/or a processor which processes the sensing data.

28. A non-transitory computer storage medium having an executable program stored thereon, wherein after the executable program is executed by a processor, the method according to claim 1 is implemented.

29. The communication device according to claim 27, wherein the sensing parameter comprises at least one of:
sensing target information;
sensing service information;
region information of the sensing service;
sensing duration information;
sensing Quality of Service (QOS) requirement information;
sensing model information;
data format information of the sensing data; or
processing algorithm information of the sensing data.

30. The communication device according to claim 29, wherein the sensing model information comprises at least one of the following models:
a first sensing model in which a sensing base station serves as a transmitter and a receiver;
a second sensing model in which User Equipment (UE) serves as the transmitter and the receiver;
a third sensing model in which a base station serves as the transmitter and the UE serves as the receiver;
a fourth sensing model in which the UE serves as the receiver and the base station serves as the transmitter; or
a fifth sensing model other than the first sensing model to the fourth sensing model.

31. The communication device according to claim 27, wherein when the instructions are executed by the processor, the communication device is caused to perform at least one of: sending the sensing parameter to the executor through a user plane; or
sending the sensing parameter to the executor through a control plane.

32. A communication device, comprising:
a processor; and
a memory configured to store instructions executable by the processor;
wherein when the instructions are executed by the processor, the communication device is caused to:
receive a sensing parameter from a sensing function; and
provide the sensing service according to the sensing parameter.

33. The communication device according to claim 32, wherein when the instructions are executed by the processor, the communication device is caused to:
receive the sensing parameter through a user plane; or,
receive the sensing parameter through a control plane.

34. The communication device according to claim 32, wherein when the instructions are executed by the processor, the communication device is caused to perform at least one of:
transmitting a sensing signal according to a transmitting parameter in the sensing parameter;
receiving, according to a receiving parameter in the sensing parameter, a reflected signal that is generated by the sensing signal acting on a sensing target, and generating sensing data based on the received reflected signal; or
processing the sensing data according to a processing parameter in the sensing parameter to obtain a sensing result.
